(19) United States
(12) Patent Application Publication
(10) Pub. No.: US 2004/0078708 A1
(43) Pub. Date: Apr. 22, 2004

(54) Methods for facilitating the installation of computer devices

(76) Inventors: Chuang Li, Saratoga, CA (US); Asif Ahsan, San Jose, CA (US)

Correspondence Address: FISH & NEAVE, 1251 AVENUE OF THE AMERICAS, 50TH FLOOR, NEW YORK, NY, 10020-1105, US

(21) Appl. No.: 10/150,983

(22) Filed: May 17, 2002

(51) Int. Cl. G06F 11/00

(52) U.S. Cl. 714/43

(57) ABSTRACT

Methods for facilitating the installation of computer devices are provided. An installation application that runs on a user's personal computer may be used to facilitate the installation of a device that is connected to the personal computer with a cable or a wireless connection. At the beginning of the installation process, the installation application may check to determine whether the user has properly formed the connection between the device and the personal computer. If the connection has not been formed properly, the user may be informed and appropriate remedial actions may be taken before the installation process is complete.

### BACKGROUND OF THE INVENTION

This application relates to the installation of computer hardware devices, and more particularly, to ways in which to reduce the potential for users to make mistakes during the installation of such devices.

There is an increasing trend to allow home users of computer equipment to install their own computer peripherals. In some situations, the use of plug-and-play operating system arrangements can simplify the tasks associated with installing such hardware devices. Plug-and-play arrangements are not, however, perfect. For example, a typical plug-and-play arrangement requires a user to connect an appropriate cable between the device being installed and the user's personal computer. The user must then reboot the computer, which restarts the user's operating system to attempt to locate and install an appropriate driver for the device. If the cable or other connection used to connect the personal computer and device is faulty, the operating system will be unable to complete the installation process. The user will generally not be informed why the installation process failed.

It is therefore an object of the present invention to provide ways in which to facilitate the installation of hardware devices by users.

### SUMMARY OF THE INVENTION

This and other objects of the invention are accomplished in accordance with the principles of the invention by providing methods that help to ensure that users can properly install computer hardware devices in their computer systems. A peripheral or hardware device installation program may be used during the installation process. The installation program may be separate from the operating system that is used to operate the user's personal computer. A user may connect a device to the personal computer using a connection such as a cable or a wireless connection. The device may also be connected by cables or other suitable connections to other equipment (e.g., by connecting the device through a cable connected to a user's telephone jack). At the beginning of the installation procedure, the installation program may check to determine whether the user has connected the cable between the personal computer and device properly or has otherwise made a proper connection. If the connection has not been made properly (e.g., due to an incorrect connection or a faulty cable), the installation program may alert the user (e.g., through an error message).

The installation program may use a low-level (physical layer) protocol or a high-level protocol to check whether the cable or other connection to the device has been properly made. An example of a suitable low-level protocol is the protocol set forth in the Universal Serial Bus (USB) Specification Rev. 1.1 § 7.1.7.1. Another example of a suitable low-level protocol is the IEEE 802.3 session protocol (§7.2.4.6). High-level protocols may also be used to perform cable-checking or other connection-checking operations, such as those that rely on Ethernet or USB control data packets. These are merely illustrative examples. Any suitable protocols or techniques may be used to detect proper formation of the user's cable or other connection if desired.

The installation program may be used to install devices such as scanners, printers, digital cameras, routers, wireless access points (such as wireless IEEE 802.11(b) Access Points), or any other suitable devices. For example, the installation program may be used during the installation of computer devices such as modems and gateways. A user may be installing computer hardware such as a broadband modem or an Internet gateway device that includes a broadband modem and a router. During installation, a modem or gateway installation application (program) may be used to monitor the cable connections that the user has made between the user's personal computer, modem or gateway, and wall jack or other system components. When the installation application determines that certain connections have not been properly made, informative messages may be displayed for the user. This provides the user with an opportunity to correct cabling or other connection errors, thereby reducing the likelihood of user confusion and mistakes. The installation application may determine whether the device has been properly connected to the user's personal computer (e.g., using a cable) without requiring the user to complete all cable or wireless connections to the device (e.g., to connect the device to the wall jack or other system components).

Further features of the invention, its nature and various advantages will be more apparent from the accompanying drawings and the following detailed description of the preferred embodiments.

### BRIEF DESCRIPTION OF THE DRAWINGS

FIG. 1 is a diagram of an illustrative system arrangement in which a personal computer is connected to a device that is being installed in accordance with the present invention.

FIG. 2 is a flow chart of illustrative steps involved in installing a device in accordance with the present invention.

FIG. 3 is a diagram of an illustrative system arrangement in which a personal computer is connected to the Internet using a modem in accordance with the present invention.

FIG. 4 is a diagram of an illustrative modem in accordance with the present invention.

FIG. 5 is a diagram of illustrative steps involved in using a modem installation application to implement a modem installation process in accordance with the present invention.

FIG. 6 is a diagram of an illustrative system arrangement in which a personal computer is connected to the Internet using a gateway in accordance with the present invention.

FIG. 7 is a diagram of an illustrative gateway in accordance with the present invention.

FIG. 8 is a diagram of illustrative steps involved in using a gateway installation application to implement a gateway installation process in accordance with the present invention.

### DETAILED DESCRIPTION OF THE PREFERRED EMBODIMENTS

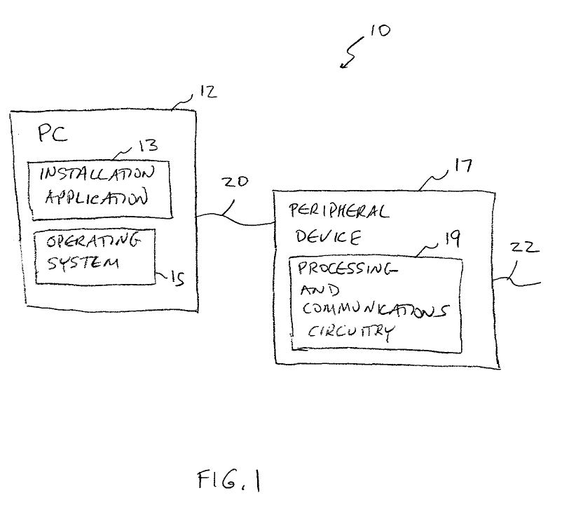

An illustrative system 10 in which a user at a personal computer 12 may install a device 17 is shown in FIG. 1. Device 17 may be a scanner, printer, digital camera, modem, gateway, router, wireless access point, or any other suitable computer device. Device 17 may include processing and communications circuitry 19 for controlling the operation of device 17 and for communicating with personal computer 12 and other devices external to device 17. Cables such as cables 20 and 22 may be used (at appropriate times) to connect device 17 to personal computer 12 and other system components (e.g., a telephone jack or a port on another device). A suitable connection between device 17 and computer 12 (or between device 17 and other system components) may also be formed using a wireless connection.

The process of installing device 17 includes unpacking device 17 from the packaging materials in which device 17 was sold, connecting power cables or installing batteries if needed, and connecting device 17 to personal computer 12 and other devices (at appropriate times) using cables such as cables 20 and 22 (e.g., one at a time) or placing device 17 close enough to computer 12 that a suitable wireless connection may be formed. The installation process also typically involves running an installation application (program) 13 that is separate from the user's operating system 15 on personal computer 12. The installation application 13 displays useful information on the monitor of personal computer 12 that guides the user through the installation process. The installation application 13 may also provide the user with various selectable on-screen options that allow the user to configure user-selectable options for device 17 (if available). During a successful installation of device 17, any driver software (if necessary) for the device may be installed on personal computer 12 for use by the operating system 15 and other software on computer 12 during subsequent operations. After installation is complete, the computer 12 may use the device to perform its intended functions (e.g., printing, scanning, supporting Internet communications, etc.).

Advantageously, installation application 13 may check whether the user has connected cables such as cables 20 and 22 properly during the installation process (or has otherwise formed a proper connection between the device and the computer, e.g., by properly placing device 17 within a suitably close proximity to computer 12 to establish a wireless connection for wireless communications). The checking process may be performed without requiring that any device driver be previously installed on the personal computer 12. If a cable connection or other connection has not been properly made, the user may be informed of the problem and remedial actions taken (e.g., to ensure the cable is properly seated in its ports, to ensure the correct type of cable is being used, to ensure that device 17 is close enough to computer 12 to form a working wireless connection, etc.). If desired, the user may be informed and any remedial actions may be taken without requiring the user to complete the entire installation process or exit the installation application 13.

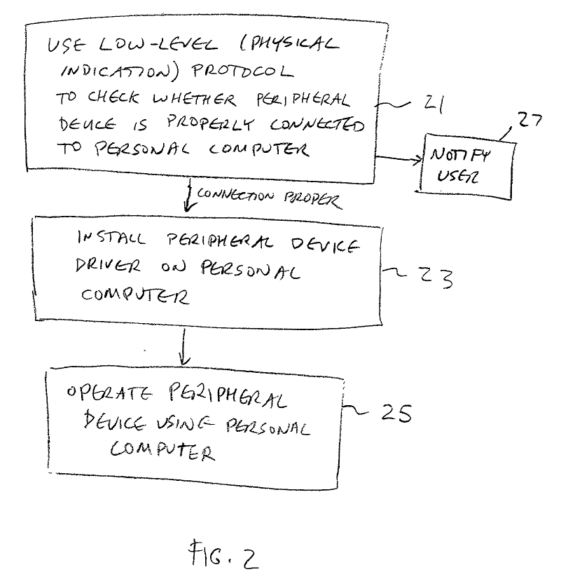

Illustrative steps involved in installing device 17 in system 10 are shown in FIG. 2. In the following examples such as the example of FIG. 2, the connection between the computer 12 and the device 17 is made using a cable. This is, however, merely illustrative. The connection that is to be formed between device 17 and computer 12 may be a wireless connection or a connection to be formed using any other suitable technique.

At step 21 of FIG. 2, after the user launches the installation application and after suitable informative screens have been displayed for the user on the monitor of computer 12 that instruct the user to connect one or more cables between device 17 and personal computer 12 and other components in the system, the installation application may check to see whether the user has connected the cables properly. Advantageously, the user may be instructed to connect the cables to device 17 one at a time and the installation application may check whether the cables have been connected one at a time. Any suitable technique may be used to check whether the cables have been connected. For example, a low-level or a high-level protocol may be used to make this determination.

An example of a suitable low-level protocol is the protocol set forth in the Universal Serial Bus (USB) Specification Rev. 1.1 § 7.1.7.1. Another example of a suitable low-level protocol is the IEEE 802.3 session protocol (§7.2.4.6). High-level protocols may also be used to perform cable-checking operations, such as those that rely on Ethernet or USB control data packets. As an example, installation application 13 may send signals to device 17 (e.g., as Ethernet control packets when cable 20 is an Ethernet cable or as USB control data packets when cable 20 is a USB cable) and may await a corresponding acknowledgement from processing and communications circuitry 19 (FIG. 1). These are merely illustrative examples. Any suitable protocols or techniques may be used to detect proper connection of the user's cable if desired. If the cable 20 is not properly connected, the user may be notified at step 27. If the cable is connected properly, the installation application 13 may proceed to step 23.

If additional cables such as cable 22 are used, the installation application 17 may check for their presence and proper connection to other devices before proceeding to step 23, but, advantageously, the installation application 17 can check whether cable 20 has been properly connected without requiring that the user complete all of the cable connections to the device—i.e., the user need not have connected additional cables such as cable 22 to other system components such as a wall jack or modem for the installation application to determine whether cable 20 is properly connected. The installation application may check whether cable 20 has been properly connected before the user can browse the Internet (i.e., before a complete Internet communication link between personal computer and the Internet or other such communication network has been formed).

At step 23, the device driver may be installed on personal computer 12. The driver may, for example, be installed from a compact disk (CD) on which the installation application is provided to the personal computer. The appropriate software for installation application 13 and the driver may also be provided to computer 12 via the Internet or any other suitable technique.

At step 25, after the device driver for peripheral 17 has been installed, the user at personal computer 12 may operate device 17. For example, if device 17 is a communication device such as a modem, or a device containing a modem, the user at personal computer 12 may use device 17 to browse the Internet.

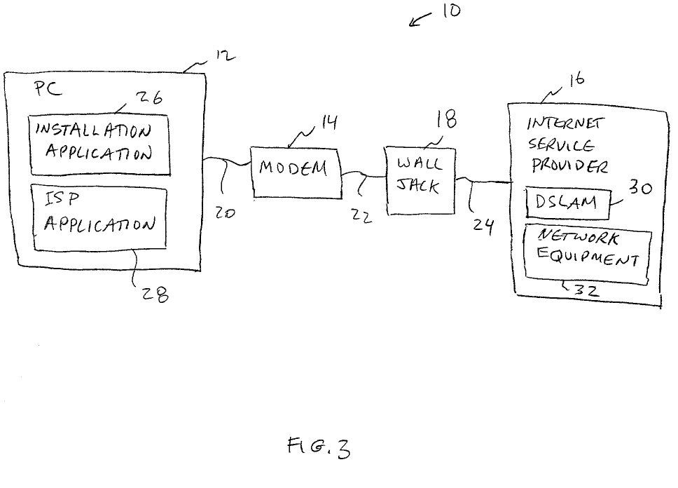

An illustrative system 10 in which a user at a personal computer 12 may connect to the Internet or another communication network is shown in FIG. 3. Personal computer 12 may use a modem 14 to support network communications. Modem 14 may be, for example, a broadband modem such as a digital subscriber line (DSL) modem or a cable modem. Modem 14 may be connected indirectly to the Internet. For example, modem 14 may be connected to a wall jack 18 or a cable outlet or other suitable receptacle, which in turn is indirectly connected to an Internet service provider 16. Internet service provider 16 may serve as a gateway to the Internet. This arrangement allows a user at computer 12 to connect to the Internet (e.g., to browse the web or to send and receive e-mail, etc.).

Various cables may be used to connect the equipment of system 10. For example, cable 20 may be used to connect personal computer 12 to modem 14. Cable 20 may be an Ethernet cable, a universal serial bus (USB) cable, or any other suitable cable or communication line that couples personal computer 12 to modem 14. The choice of a suitable cable is typically dictated by the hardware requirements and capabilities of the equipment of system 10. For example, if modem 14 and computer 12 have USB ports, a USB cable may be used to connect computer 12 and modem 14. If modem 14 and computer 12 each have Ethernet ports, an Ethernet cable may be used.

Cable 22 may be used to connect modem 14 to wall jack 18. Wall jack 18 may be, for example, a phone jack attached to the wall of a user's home or office. If desired, other types of jacks may be used that are not attached to a home or office wall. For illustrative purposes, however, the present invention will be discussed in the context of jacks that are mounted in a user's wall (i.e., wall jacks or other suitable equipment).

In some system configurations, personal computer 12 may be connected by a first cable to a router and by a second cable to a modem, which in turn is connected by a third cable to the wall jack or other suitable receptacle or outlet. Other system configurations are also possible in which personal computer 12 is indirectly connected to the Internet or another suitable communication network by multiple cables or wireless connections passing through a modem or other hardware device. Advantageously, the installation application can be used to determine whether any additional connections made between the device and any additional parts or components of the system (e.g., a modem, wall jack, or other system components besides the device itself) have been made properly as well as determining whether the connection between the device and personal computer has been made properly.

The internal wiring in the user's premises and the wiring that connects the user's premises to service provider 16 is shown in FIG. 3 as communication line or path 24.

The service provider 16 may be an Internet service provider that uses digital subscriber line access multiplexer equipment (DSLAM) 30 and network equipment 32 to link multiple customers to a high-speed Internet connection. If desired, the DSLAM 30 (or other suitable equipment that allows multiple users to connect to the Internet) may be located at a telephone company's central office that is separate from Internet service provider 16. For clarity, an arrangement in which DSLAM 30 and Internet service provider 16 are at the same location is shown in FIG. 3. This is, however, merely illustrative. Any suitable service provider arrangement that allows a user at computer 12 to connect to the Internet or other communications network with modem 14 may be used if desired.

Personal computer 12 may be any suitable computer such as a desktop or laptop computer. Software that is implemented on computer 12 may be used to assist a user when installing modem 14 for the first time and may be used to support communications between computer 12 and other equipment on the communications network.

The software package that is used to assist the user in installing modem 14 may, for example, be a modem installation program that is provided to the user on a compact disc (CD) or other suitable medium by the manufacturer of modem 14. This is, however, merely one illustrative arrangement. Any other suitable arrangement for providing the installation software to the user and personal computer 12 may be used if desired. For example, software that is fully or partly embedded in the computer's operating system may be used to support the modem installation process. For the present discussion, it is not necessary to draw distinctions between operating system software, middleware, and application level software. Accordingly, the modem installation process of the present invention will be described primarily in the context of a user who is using a modem installation application 26 that runs on computer 12.

The modem installation application 26 may operate in conjunction with a communication application 28 that is provided by the user's Internet service provider (ISP) 16. The application may, for example, be provided to the user on a compact disc by the user's service provider when the user subscribes to Internet service. After modem 14 has been properly installed in system 10, ISP application 28 may be used to allow personal computer 12 to connect to network equipment 32 at ISP 16 or other suitable communication equipment and thereby connect to the Internet.

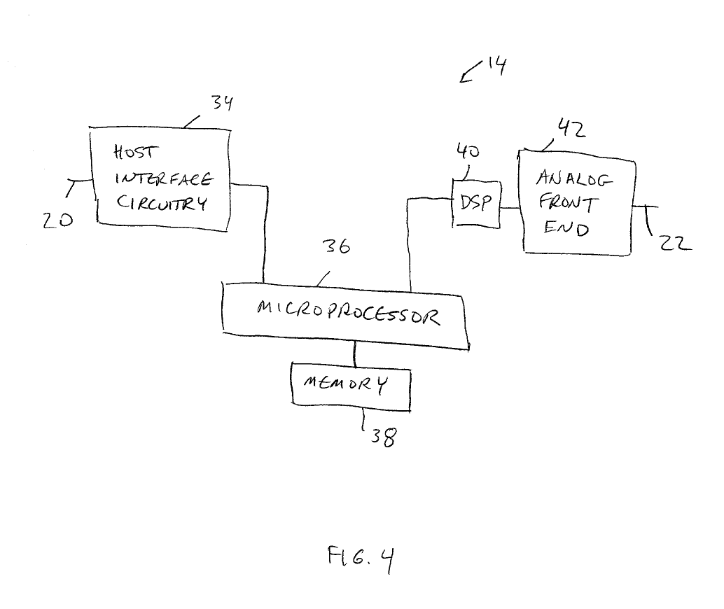

The components of an illustrative modem 14 are shown in FIG. 4. Modem 14 may have host interface circuitry 34 for supporting communications with personal computer 16 over cable 20. Modem 14 may also have a processor such as microprocessor 36 and memory 38 for supporting communications and controlling the operation of the other components in modem 14. Digital signal processor 40 and analog front end 42 may be used to support communications with Internet service provider 16 over cable 22. The arrangement shown in FIG. 4 is merely illustrative. Other suitable modem architectures may be used if desired.

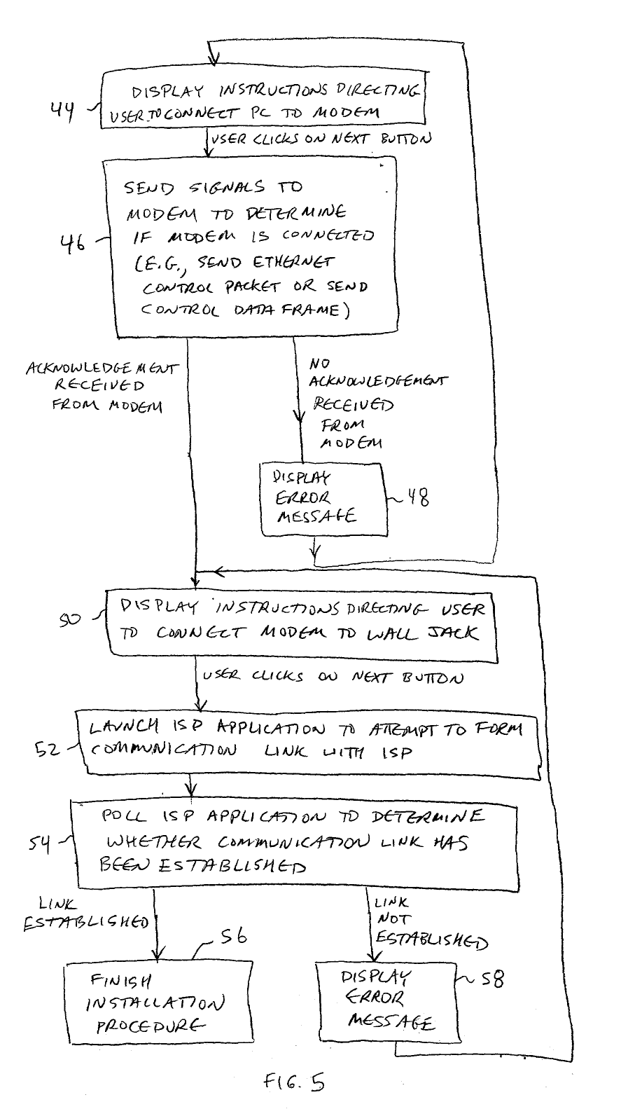

Illustrative steps involved in using modem installation application 26 (FIG. 3) to support the installation of modem 14 are shown in FIG. 5. The installation application may be launched automatically (e.g., when the CD on which the installation application is provided is placed in the CD drive of computer 16) or may be launched manually (e.g., when run in response to commands entered by the user). The installation process may involve providing the user with various menu options and on-screen instructions.

The instructions may, if desired, include photographic images of the various cables and other parts being installed in system 10. The images may help the user identify unfamiliar parts. Color coding may be used in the on-screen instructions and on the cables 20 and 22 and modem 14 to avoid confusion as to which cables are suitable for plugging into particular ports.

Selectable options such as “OK,” “FINISH,” “NEXT,” and “BACK” or other suitable options may be provided so that the user may interact with the installation application. The screens provided by the installation application may occupy the entire screen of the computer monitor in computer 12 or may occupy only a portion of the monitor real estate (e.g., as a small pop-up window). If desired, a combination of these user interface designs or other suitable designs may be used.

The instructions provided to the user by the installation application help the user to unpack and install modem 14 in system 10. For example, the instructions may inform the user of the proper procedures for connecting a power cord between the user's power outlet and the modem 14. The instructions may also inform the user of the procedures to be used to install filter components that allow the user to connect a telephone to the same wall jack being used for the user's modem connection. The instructions may be written in a straightforward manner with a minimum of computer jargon.

A user may not be familiar with the process of installing new hardware for computer 12. Accordingly, the installation application may monitor whether cables 20 and 22 are being attached properly during the installation process. If a cable is not connected properly, or if the wrong type of cable is used (e.g., if a crossover Ethernet cable is used instead of a regular Ethernet cable), the installation application may notify the user of the error in real time, thereby avoiding problems as soon as they are detected (or at least before the user has proceeded too far into the installation process).

As shown in FIG. 5, during the modem installation process, the installation application 26 may, at step 44, display instructions that direct the user to install cable 20. The user may, for example, be directed to plug one end of a color-coded cable 20 (e.g., a yellow cable) into the appropriate color-coded (e.g., yellow) receptacle on modem 14. The installation instructions provided at step 44 may also direct the user to attach the other end of cable 20 to an appropriate port on computer 12.

At step 46, after the user has advanced to the next step of the installation process (e.g., by clicking on a NEXT button or other suitable selectable on-screen option), the installation application 26 may send signals to modem 14 to determine whether cable 20 has been properly connected between computer 12 and modem 14. If, for example, the user has forgotten to attach cable 20 to modem 14, the signals will not reach modem 14 and the installation application will detect this as an error condition. The installation application 26 can determine whether the user has properly connected the cable between the personal computer and the modem 14 without requiring the user to connect the modem 14 to the wall jack 18.

Any suitable signals may be sent at step 46. For example, if computer 12 and modem 14 are connected by an Ethernet cable, the signals that are sent may take the form of one or more Ethernet control packets. If computer 12 and modem 14 are connected by a USB cable, the signals that are sent may take the form of one or more control data packets. The signals that are sent direct modem 14 to respond to computer 12. If modem 14 receives the signals, modem 14 will send a corresponding acknowledgement to computer 12.

After sending the signals to modem 14 at step 46, computer 12 monitors incoming signals on the port connected to cable 20. If an acknowledgement (e.g., an ACK signal) is received from modem 14 in response to the signal that was sent from computer 12 at step 46, the installation application 26 may display additional instructions for the user at step 50. If no acknowledgement is received, an error message may be displayed for the user at step 48. For example, an error message may be displayed that states that the cable 20 is not connected properly. Control may then loop back to step 44, so that the initially-displayed instructions for the user may be displayed again, providing the user with a second opportunity to attempt to connect cable 20 properly. Because the error message is provided at an early stage in the installation process, this approach prevents the user from proceeding too far with the modem installation when everything is not working properly.

The error message that is displayed at step 48 may be displayed immediately (in real time) as soon as application 26 detects the missing acknowledgement signal. Alternatively, a timer-based approach may be used (e.g., a timer may be initiated when the application 26 sends the signal to modem 14 at step 46). When a timer-based approach is used, the user will be provided with the error message of step 48 only if application 26 has not received an acknowledgement signal and a predetermined amount of time has elapsed.

When an acknowledgement signal or other suitable signal is received over cable 20 by computer 12, the installation application 26 can conclude that cable 20 has been properly connected between a port on computer 12 and the appropriate port on modem 14. The installation application may therefore proceed to display additional installation instructions for the user at step 50. In particular, installation application 26 may display instructions for the user at step 50 that direct the user to connect a color-coded (e.g., blue) cable 22 between an appropriate color-coded (e.g., blue) modem port on modem 14 and the user's home or office wall phone outlet (jack 18). When the user clicks on a NEXT button or other appropriate user-selectable on-screen option, the installation application may launch ISP application 28 (FIG. 3) at step 52 to attempt to establish communications between computer 12 and ISP 16.

At step 54, while the ISP application is attempting to form a communication link with ISP 16, the installation application may monitor the status of the communication link. For example, the installation application may repeatedly poll the ISP application to determine whether the ISP application has completed the procedures necessary to form a communication link between personal computer 12 and Internet service provider 16. If the ISP application successfully establishes a communication link, the installation application may proceed to step 56 to complete the installation process. For example, the installation application may, at step 56, provide additional instruction screens for the user that guide the user through the remaining steps of installing modem 14 in system 10.

If, however, the ISP application 28 fails to establish a communication link with ISP 16, this indicates that cable 22 may not have been properly connected between modem 14 and wall jack 18. Accordingly, installation application 26 may display an error message for the user at step 58. A suitable error message may, for example, inform the user that cable 22 may not have been connected to the proper ports or could not be detected by the system. This provides the user with an opportunity to properly connect cable 22 before proceeding further with the installation process at step 50. The installation application 26 can therefore determine whether the user has properly connected the cable 22 between the modem 14 and wall jack 18 without requiring the user to have completed the modem installation process at step 56.

The monitoring process of step 54 may begin as soon as the user clicks on the next button (after step 50), so that the error message of step 58 may be displayed in real time. If desired, a predetermined amount of time may be allocated to allow ISP application 28 to establish its link with ISP 16. During the polling process of step 54, installation application 26 will only deem the connection efforts of ISP application 28 to have failed if a timer exceeds a predetermined timer value (e.g., several seconds or minutes). With this arrangement, it is not required that ISP application 28 establish communications with ISP 16 instantaneously. This is merely one illustrative example of how a timer-based approach may be used. If desired, other suitable timer-based approaches may be used.

The cable-monitoring features of modem installation application 26 help to make the process of installing modem 12 more foolproof, because users are not even permitted to begin the final steps required to set up and use their Internet connection until after it has been determined that suitable cables 20 and 22 have been properly attached between computer 12, modem 14, and wall jack 18. Accordingly, this approach makes it easier for inexperienced users to install their own broadband modems without resorting to the assistance of their service provider's customer support services.

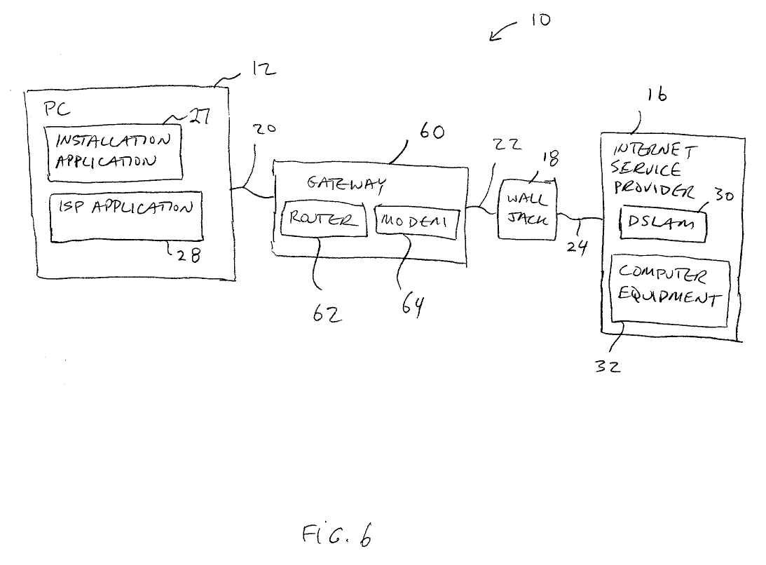

Systems and methods may also be provided that assist users in installing other customer premises equipment such as gateway devices that include integrated modem and router capabilities. As shown in FIG. 6, a user may, for example, desire to install a gateway 60 in system 10 that has an internal router 62 and broadband modem 64 (e.g., a DSL modem such as modem 14 of FIG. 3). Personal computer 12 may use gateway 60 to support network communications. Router 62 may be, for example, a router based on a multi-port Ethernet switch architecture that allows multiple personal computers to share a single broadband connection.

The modem 64 and gateway 60 may be connected to a wall jack 18, which in turn is connected to an Internet service provider 16. Internet service provider 16 may serve as a gateway to the Internet. This arrangement allows a user at computer 12 to connect to the Internet (e.g., to browse the web or to send and receive e-mail, etc.).

Cables may be used to connect the equipment of system 10. For example, cables such as cable 20 may be used to connect one or more personal computers 12 to gateway 60. Cable 20 may be an Ethernet cable, a universal serial bus (USB) cable, or any other suitable cable or communication line that couples personal computer 12 to gateway 60. The choice of a suitable cable is typically dictated by the hardware requirements and capabilities of the equipment of system 10. For example, if gateway 60 and computer 12 have USB ports, a USB cable may be used to connect computer 12 and gateway 60. If gateway 60 and computer 12 each have Ethernet ports, an Ethernet cable may be used.

Cable 22 may be used to connect gateway 60 to wall jack 18. Wall jack 18 may be, for example, a phone jack attached to the wall of a user's home or office. If desired, other types of jacks may be used that are not attached to a home or office wall. For illustrative purposes, however, the present invention will be discussed in the context of jacks that are mounted in a user's wall (i.e., wall jacks).

The internal wiring in the user's premises and Adz the wiring that connects the user's premises to service provider 16 is shown as communication line or path 24 in FIG. 6.

The service provider 16 may be an Internet service provider that uses digital subscriber line access multiplexer equipment (DSLAM) 30 and network equipment 32 to link multiple customers to a high-speed Internet connection, as described in connection with FIG. 3. If desired, the DSLAM 30 (or other suitable equipment that allows multiple users to connect to the Internet) may be located at a telephone company's central office that is separate from Internet service provider 16. For clarity, an arrangement in which DSLAM 30 and Internet service provider 16 are at the same location is shown in FIG. 6. This is, however, merely illustrative. Any suitable service provider arrangement that allows a user at computer 12 to connect to the Internet or other communications network with modem 14 may be used if desired.

Personal computer 12 may be any suitable computer such as a desktop or laptop computer. Software that is implemented on computer 12 may be used to assist a user when installing gateway 60 for the first time and may be used to support communications between computer 12 and other equipment on the communications network.

The software package that is used to assist the user in installing gateway 60 may, for example, be a gateway installation program that is provided to the user on a compact disc (CD) or other suitable medium by the manufacturer of gateway 60. This is, however, merely one illustrative arrangement. Any other suitable arrangement for providing the installation software to the user and personal computer 12 may be used if desired. For example, software that is fully or partly embedded in the computer's operating system may be used to support the gateway installation process. For the present discussion, it is not necessary to draw distinctions between operating system software, middleware, and application level software. Accordingly, the gateway installation process of the present invention will be described primarily in the context of a user who is using a gateway installation application 27 that is running on computer 12.

The gateway installation application 27 may operate in conjunction with a communication application 28 that is provided by the user's Internet service provider (ISP) 16. The application may, for example, be provided to the user on a compact disc by the user's service provider when the user subscribes to Internet service. After gateway 60 has been properly installed in system 10, ISP application 28 or embedded client software on computer 12 may be used to allow personal computer 12 to connect to network equipment 32 or other suitable communication equipment at ISP 16 through gateway 60 and thereby connect to the Internet.

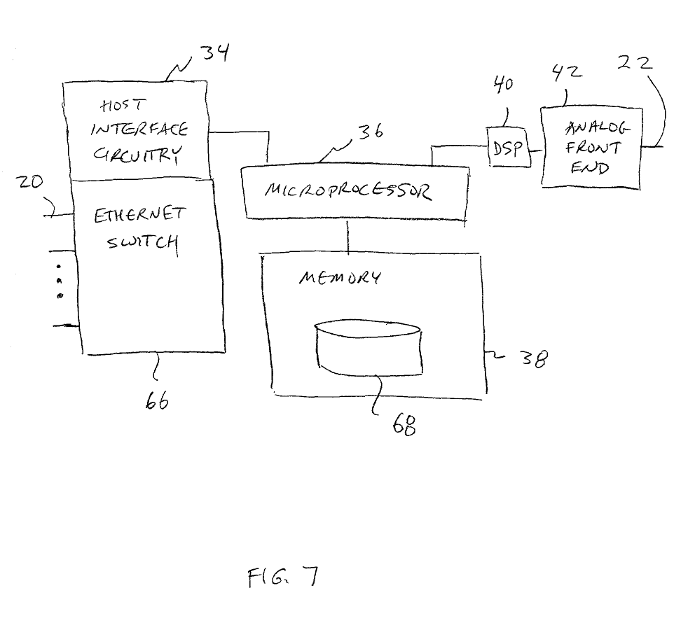

The components of an illustrative gateway 60 are shown in FIG. 7. Gateway 60 may have host interface circuitry 34 for supporting communications with personal computer 16 over cable 20. Ethernet switch 66 may be used to connect gateway 60 to multiple personal computers using cables such as cable 20. Gateway 60 may have a processor such as microprocessor 36 and memory 38 for supporting communications and controlling the operation of the other components in gateway 60. A database 68 may be implemented using memory 38. During operation, when gateway 60 establishes a communications link with ISP 16, parameters (e.g., IP addresses, etc.) that are passed to gateway 60 from ISP 16 may be stored in database 68. The database 68 may be queried by personal computer 12 to determine whether gateway 60 has or has not established communications with ISP 16. Gateway 60 may use a digital signal processor 40 and analog front end 42 to support communications with Internet service provider 16 over cable 22. The arrangement shown in FIG. 7 is merely illustrative. Other suitable gateway architectures may be used if desired.

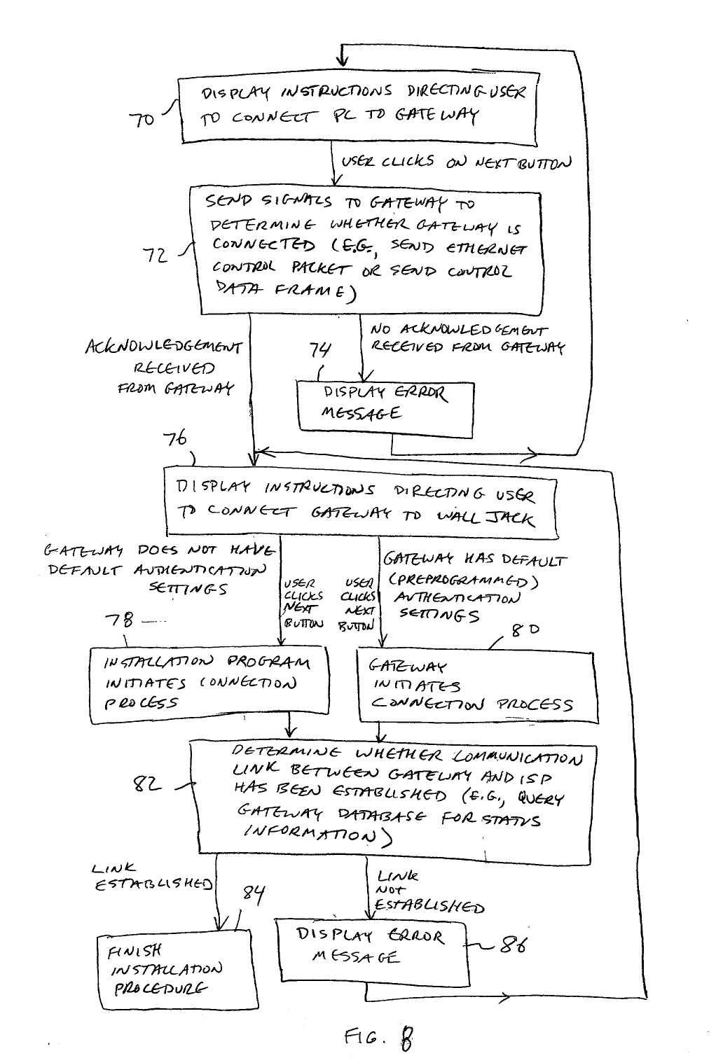

Illustrative steps involved in using gateway installation application 27 (FIG. 6) to support the installation of gateway 60 are shown in FIG. 8. The installation application may be launched automatically (e.g., when the CD on which the installation application is provided is placed in the CD drive of computer 16) or may be launched manually (e.g., when run in response to commands entered by the user). The installation process may involve providing the user with various menu options and on-screen instructions.

As with the installation application 26 that is used to install modem 14 of FIG. 3, the installation application 27 that is used to install gateway 60 of FIG. 6 may provide the user with on-screen instructions. The instructions may, if desired, include photographic images of the various cables and other parts being installed in system 10. The images may help the user identify unfamiliar parts. Color coding may be used in the on-screen instructions and on the cables 20 and 22 and gateway 60 to avoid confusion as to which cables are suitable for plugging into particular ports.

Selectable options such as “OK,” “FINISH,” “NEXT,” and “BACK” or other suitable options may be provided so that the user may interact with the installation application. The screens provided by the installation application may occupy the entire screen of the computer monitor in computer 12 or may occupy only a portion of the monitor real estate (e.g., as a small pop-up window). If desired, a combination of these user interface designs or other suitable designs may be used.

The instructions provided to the user by the installation application help the user to unpack and install gateway 60 in system 10. For example, the instructions may inform the user of the proper procedures for connecting a power cord between the user's power outlet and the gateway 60. The instructions may also inform the user of the procedures to be used to install filter components that allow the user to connect a telephone to the same wall jack being used for the user's modem connection. The instructions may be written in a straightforward manner with a minimum of computer jargon.

A user may not be familiar with the process of installing new hardware for computer 12. Accordingly, the installation application may monitor whether cables 20 and 22 are being attached properly during the installation process. If a cable is not connected properly, or if the wrong type of cable is used (e.g., if a crossover Ethernet cable is used instead of a regular Ethernet cable), the installation application may notify the user of the error in real time, thereby avoiding problems as soon as they are detected (or at least before the user has proceeded too far into the installation process).

As shown in FIG. 8, during the gateway installation process, the installation application 27 may, at step 70, display instructions that direct the user to install cable 20. The user may, for example, be directed to plug one end of a color-coded cable 20 (e.g., a yellow cable) into the appropriate color-coded (e.g., yellow) receptacle on gateway 60. The installation instructions provided at step 70 may also direct the user to attach the other end of cable 20 to an appropriate port on computer 12.

At step 72, after the user has advanced to the next step of the installation process (e.g., by clicking on a NEXT button or other suitable selectable on-screen option), the installation application 27 may send signals to gateway 60 to determine whether cable 20 has been properly connected between computer 12 and gateway 60. If, for example, the user has forgotten to attach cable 20 to gateway 60, the signals will not reach gateway 60 and the installation application will detect this as an error condition. The installation application 27 can determine whether the user has properly connected the cable between the personal computer and the gateway 60 without requiring the user to connect the gateway 60 to the wall jack 18.

Any suitable signals may be sent at step 72. For example, if computer 12 and gateway 60 are connected by an Ethernet cable, the signals that are sent may take the form of one or more Ethernet control packets. If computer 12 and gateway 60 are connected by a USB cable, the signals that are sent may take the form of one or more control data packets. The signals that are sent direct gateway 60 to respond to computer 12. If gateway 60 receives the signals, gateway 60 will send a corresponding acknowledgement to computer 12.

After sending the signals to gateway 60 at step 72, computer 12 monitors incoming signals at the port connected to cable 20. If an acknowledgement is received from gateway 60 in response to the signal that was sent from computer 12 at step 72, the installation application 27 may display additional instructions for the user at step 76. If no acknowledgement is received, an error message may be displayed for the user at step 74. For example, an error message may be displayed that states that the cable 20 is not connected properly. Control may then loop back to step 70, so that the initially-displayed instructions for the user may be displayed again, providing the user with a second opportunity to attempt to connect cable 20 properly. Because the error message is provided at an early stage in the installation process, this approach prevents the user from proceeding too far with the gateway installation when everything is not working properly.

The error message that is displayed at step 74 may be displayed immediately (in real time) as soon as application 27 detects the missing acknowledgement signal (or when application 27 otherwise determines that gateway 60 is not responding to computer 12). Alternatively, a timer-based approach may be used (e.g., a timer may be started when the application 27 sends the signal to gateway 60 at step 72). When a timer-based approach is used, the user will be provided with the error message of step 74 only if application 27 has not received an acknowledgement signal and a predetermined amount of time has elapsed.

When an acknowledgement signal or other suitable signal is received over cable 20 by computer 12, the installation application 27 can conclude that cable 20 has been properly connected between a port on computer 12 and the appropriate port on gateway 60. The installation application may therefore proceed to display additional installation instructions for the user at step 76. In particular, installation application 27 may display instructions for the user at step 76 that direct the user to connect a color-coded (e.g., blue) cable 22 between an appropriate color-coded (e.g., blue) port on gateway 60 and the user's home or office telephone wall outlet (jack 18).

As the user clicks on a NEXT button or other appropriate user-selectable on-screen option, attempts may be made to use gateway 60 to establish a communication link with ISP 16. The way in which this communication link is formed may depend on whether gateway 60 has been preprogrammed with appropriate authentication information (e.g., username and password information) for logging into ISP 16. If gateway 60 has not been provided with default authentication information at the factory, computer 12 may initiate the installation process for gateway 60 at step 78. For example, application 27 or other software on computer 12 may be used to launch ISP application 28 to attempt to connect to ISP 16 through gateway 60. If gateway 60 has been provided with default settings that allow gateway 60 to autonomously attempt to initiate communications with ISP 16, the gateway may do so at step 80.

Regardless of which process is used to attempt to form a communication link with ISP 16, at step 82, installation application 27 may determine whether the link has been successfully formed. As an example, installation application 27 may examine information contained in database 68 that reflects the status of the communication link. If the information in database 68 of memory 38 indicates that the communication link has been successfully formed, the installation application may proceed to step 84 to finish the installation process.

If, however, the installation application determines that a communication link with ISP 16 has not been formed through gateway 60, this indicates that cable 22 may not have been properly connected between gateway 60 and wall jack 18. Accordingly, installation application 27 may display an error message for the user at step 86. A suitable error message may, for example, inform the user that cable 22 may not have been connected to the proper ports or could not be detected by the system. This provides the user with an opportunity to properly connect cable 22 before proceeding further with the installation process at step 76. The installation application 27 can therefore determine whether the user has properly connected the cable 22 between the gateway 60 and wall jack 18 without requiring the user to have completed the gateway installation process at step 84.

The monitoring process of step 82 may begin as soon as the user clicks on the next button (after step 76), so that the error message of step 86 may be displayed in real time. If desired, a predetermined amount of time may be allocated to allow the link to be established. During this time, installation application 27 will only deem the connection efforts to have failed if a timer exceeds a predetermined timer value (e.g., several seconds or minutes). With this arrangement, it is not required that communications with ISP 16 be established instantaneously. This is merely one illustrative example of how a timer-based approach may be used during installation of gateway 60. If desired, other suitable timer-based approaches may be used.

The cable-monitoring features of gateway installation application 27 help to make the process of installing gateway 60 more foolproof, because users are not even permitted to begin the final steps required to set-up and use their Internet connection until after it has been determined that suitable cables 20 and 22 have been properly attached between computer 12, gateway 60, and wall jack 18. Accordingly, this approach makes it easier for inexperienced users to install their own broadband gateways without resorting to the assistance of their service provider's customer support services.

It will be understood that the foregoing is merely illustrative of the principles of this invention, and that various modifications can be made by those skilled in the art without departing from the scope and spirit of the invention.

The invention claimed is:

1. A method for installing a device that connects to a personal computer through a connection, the method comprising:
providing an installation application and a device;
attempting to connect the device to the computer through the connection;
executing the installation application to determine whether the connection has been properly formed; and
generating an error message when it is determined that the connection between the device and the personal computer has not been properly formed.

2. The method defined in claim 1 wherein the device comprises a modem and wherein executing the installation application determines whether a cable between the modem and the personal computer has been connected properly.

3. The method defined in claim 1 wherein the device comprises a router and wherein executing the installation application determines whether a cable between the router and the personal computer has been connected properly.

4. The method defined in claim 1 wherein the device comprises a gateway that includes a modem and a router and wherein executing the installation application determines whether a cable between the gateway and the personal computer has been connected properly.

5. The method defined in claim 1 wherein the device comprises a wireless access point and wherein executing the installation application determines whether the device has been properly placed in a suitable proximity to the personal computer to support wireless communications between the device and the personal computer.

6. The method defined in claim 1 wherein executing the installation application comprises executing a low-level protocol.

7. The method defined in claim 6 wherein executing the low-level protocol comprises executing a protocol that conforms to the Universal Serial Bus (USB) Specification Rev. 1.1 § 7.1.7.1.

8. The method defined in claim 6 wherein executing the low-level protocol comprises executing a protocol that conforms to the IEEE 802.3 session protocol (§7.2.4.6).

9. The method defined in claim 1 wherein executing the installation application causes at least one control packet to be sent from the personal computer to the device.

10. The method defined in claim 9 further comprising monitoring the device to receive an acknowledgement from the device after the control packet has been sent.

11. The method defined in claim 1 wherein executing the installation application determines whether the device has been properly connected to an additional system component with an additional connection.

12. The method defined in claim 1 wherein the connection comprises a USB cable and wherein executing the installation application determines whether the USB cable has been properly connected between the device and the personal computer.

13. The method defined in claim 1 wherein the connection comprises an Ethernet cable and executing the installation application determines whether the Ethernet cable has been connected properly between the personal computer and the device.

14. The method defined in claim 1 wherein the connection between the device and the personal computer comprises a first cable and wherein the device is connected to the Internet using a second cable and wherein the installation application checks to determine whether the second cable has been connected properly before the user can browse the Internet using the second cable.

15. A method for installing a device that connects to a personal computer through a cable, comprising:
executing an installation application during a device installation process to provide an on-screen instruction directing a user how to connect a cable between the personal computer and the device;
determining whether the user has properly connected the cable between the personal computer and the device; and
generating an error message if it is determined that the user has failed to properly connect the cable between the personal computer and the device.

16. The method defined in claim 15 further comprising executing the installation application during the device installation process to determine whether the user has properly connected the cable without requiring that the user complete all cable connections to the device.

17. The method defined in claim 15 wherein determining whether the user has properly connected the cable between the personal computer and the device comprises:
sending signals from the computer to the device; and
monitoring the device to await an acknowledgement from the device.

18. The method defined in claim 15 wherein the cable is an Ethernet cable and wherein determining whether the user has properly connected the cable between the personal computer and the device comprises:
sending at least one Ethernet control packet from the computer to the device; and
monitoring the device to await an acknowledgement from the device.

19. The method defined in claim 15 wherein the cable is a USB cable and wherein determining whether the user has properly connected the cable between the personal computer and the device comprises:
sending at least one control data packet from the computer to the device; and
monitoring the device to await an acknowledgement from the device.

20. The method defined in claim 15 further comprising determining whether the user has properly connected an additional cable between the device and an additional system component.

21. The method defined in claim 20 wherein the additional system component comprises a wall jack, the method further comprising determining whether the user has properly connected the additional cable between the device and the wall jack.

22. The method defined in claim 15 further comprising determining whether the user has properly connected an additional cable between the device and an additional system component by launching an Internet service provider application that attempts to establish a communication link between the personal computer and an Internet service provider.

23. The method defined in claim 15 wherein the device comprises a modem, the method further comprising:
determining during the device installation process whether the user has properly connected an additional cable between the device and an additional system component by launching an Internet service provider application that attempts to establish a communication link between the personal computer and an Internet service provider; and
generating an error message if it is determined that the user has failed to properly connect the additional cable between the device and the additional system component.
